(19) United States
(12) Patent Application Publication
(10) Pub. No.: US 2005/0187793 A1
(43) Pub. Date: Aug. 25, 2005

(54) Prescription benefits network mechanism

(76) Inventor: Kennith Myles, Coppell, TX (US)

Correspondence Address: STOCKWELL & ASSOCIATES, PSC, 861 CORPORATE DRIVE, SUITE 201, LEXINGTON, KY, 40503, US

(21) Appl. No.: 11/057,294

(22) Filed: Feb. 11, 2005

Related U.S. Application Data
(60) Provisional application No. 60/546,749, filed on Feb. 23, 2004.

(51) Int. Cl. G06F 17/60

(52) U.S. Cl. 705/2

(57) ABSTRACT

A method and apparatus for managing medical costs including prescription medicines is disclosed. A variety of cost-saving mechanisms are contemplated, which will be provided to purchasers via a specialized magnetic card.

### CROSS-REFERENCE TO RELATED APPLICATIONS

This application claims priority to U.S. Provisional Application No. 60/546,749, which was filed on Feb. 23, 2004.

### FIELD OF THE INVENTION

This invention relates generally to prescription benefit networks.

### BACKGROUND OF THE INVENTION

It is well-known that medical costs are extremely high and rapidly rising. Specifically, prescription drugs are having a tremendous negative impact on overall ability to contain healthcare costs. For at least the above reasons, it is clear that a means for more effectively providing affordable health care and medicines to the uninsured and those below the poverty line is desired.

### SUMMARY OF THE INVENTION

This invention has as its primary objective to provide an effective prescription benefit network mechanism. This and other objects and advantages of the invention will become readily apparent as the following description is read in conjunction with the accompanying drawings.

### BRIEF DESCRIPTION OF THE DRAWINGS

FIG. 1 is a block diagram of an overview the present invention and how it fits within the overall medical industry.

### DETAILED DESCRIPTION OF THE PREFERRED EMBODIMENTS

The following description should be considered as an example only, and the present invention should not be considered as limited thereto. Modifications and updates may be made and still remain within the spirit and scope of the present invention.

Through various contractual arrangements which will be described in more detail below, the present invention will enable and facilitate direct access to a well establish pharmaceuticals companies enormous functional infrastructure that is required to dispense drugs at the appropriate level of sophistication.

In 2003, lawmakers in 40 states introduced initiatives aimed at curbing costs for prescription medicine. The initiatives vary, with some states seeking additional manufacturer rebates to save themselves money in their health programs for the poor. Other programs are aimed at consumers, creating special bulk purchasing pools or requiring manufacturers to lower prices to the elderly the poor or those without insurance. One mission of the present invention is to assist the 41 million Americans, including 9 million children, currently without benefits, or average Americans who can't even cover themselves for preventative healthcare. Also, these numbers do not reflect underinsured individuals. The present invention works in harmony with and seeks to take further advantage of such initiatives.

Generic Initiatives Among Insurers

Various generic drug initiatives reflect growing frustration among insurers and employers over the cost of prescription drugs and the pharmaceutical industry's ability to promote them with potent direct-to-consumer advertising. To encourage people to switch to unfamiliar generic medicines, one pharmaceutical company sent letters to more than a million Glucophage users. It placed billboard ads in subways and buses in poor neighborhoods where diabetes rates are high, offering coupons for a month's worth of the their generic brand.

In an effort to address the above problem, this company has hired a team of salesmen to comb through patients medical records, with doctors permission, to identify those patients who aren't controlling their diabetes well. Thus, Glucophage and others could become approved candidates for replacing the more expensive diabetes medicines.

A medicine such as Prozac is a particularly tempting target for such initiatives. For example, within days of generic Fluoxetine's arrival on the market, pharmaceutical giant Merck-Medco contacted more than 2500 Prozac-prescribing doctors to urge them to switch to Fluoxetine. One Prescription Drug Manager (PDM) company with 47 million members persuaded 75% of doctors who specifically prescribed Prozac using a “Dispense As Written” (DAW) box on the prescription form to remove the DAW designation and instead switch to generic Fluoxetine once it became available. The present invention seeks to exploit the advantages of and reward companies for participating in such aggressive cost-cutting behavior.

Pediatric Testing

Another program for reducing medicinal costs is in the area of testing pediatric medicines. Because of economics of scale, pharmaceutical companies first test mainly their big-selling drugs where an extended market for that medicine exists. Thus, only recently are some companies moving to test lesser-selling drugs about which pediatricians have long wanted data. However, these pharmaceutical companies often request that their medicines be used exclusively to address a specific health concern.

This inducement of exclusivity is a potent way to entice pharmaceutical manufacturers to sign up as participants within the present invention. The economic incentives associated with the present invention is used to induce these companies to move more quickly on researching a wider variety and spectrum of medicines, including those for which the company would normally have less economic incentive to research, such as pediatric medicines. For example, the right to allow their medicines to be used in a testing program could be packaged so that an entire spectrum of a company's medicines could be used, rather than only those medicines which have a strong market potential. This could shift the economic incentives of the pharmaceutical company to serve a larger segment of the population that is presently disadvantaged by no or limited access to effective health care. The present invention works in harmony with and seeks to take advantage of these initiatives.

New Florida Medicaid Initiative

A recent Florida Medicaid program is launching a new campaign to reduce prices of medicines within certain formularies, by according them preferential status. Specifically, the State of Florida will offer to pharmaceuticals makers to offer steep discounts for medicines they want considered for the roster. Called a formulary, the approved list will largely determine which drugs are included in the pharmaceutical purchases for a state's poor, indigent, or other people without benefits.

To participate, pharmaceutical manufacturers must agree to pay substantial but undisclosed discounts in the form of rebates to participate in the drug-selection process. Their offers would have to include a total rebate (at the counter) in excess of 25% and perhaps as much as 60% of the drug's price, as established in a master list complied by Florida health officials. A panel of drug's experts can also consider medical factors in assembling the formulary. The new Florida law allows companies to offer services to Medicaid.

The anticipated changes set-off a scramble among drug companies to respond with discounts or other offer or risk losing access to the Florida Medicaid market. The list will be reviewed at least quarterly. Making the list is important to the drug companies, because cooperating with state governments and agencies in reducing medical costs, yet while still gaining exposure for their products is in everyone's best interests.

However, officials in charge of the Florida initiative have considered a variety of alternative schemes. For example, such Florida officials said they reached an agreement with Pfizer Inc. that includes all the company's medicines on the formulary without additional rebates. Instead, Pfizer will create and fund an initiative to improve the care of high-cost chronically ill parents, which the company guarantees will save the state $33 million during two years. The present invention works in harmony with and seeks to take further advantage of such initiatives.

Purchasing Pools

Seeking to control rapidly escalating prescription-drug costs that threaten to swamp health insurance budgets, officials from a half dozen states are expected to lay the groundwork for forming a multi-State drug purchasing pool. Once they assemble more than a million states employees, retires and their families managed under a single Pharmaceutical Benefits Manager (PBM) and use the combined leverage to demand steep rebates from drug companies, If successful, this would be the first pool of employee's from different states. The present invention works in harmony with and seeks to take further advantage of such initiatives.

US FDA's 505(b)(2) Initiative

The U.S. Food and Drug Administration (FDA) has recently signaled that it will allow makers of some generic drugs to use a little known route to approval that could shave years off their time to reach the market. This alternate route could also eventually be used to approve the first generation of generic biotechnology drugs, such as human growth hormone and insulin. Most generic drugs makers support the alternate application route and see business opportunities there. The present invention provides a means for assisting in exploiting such opportunities.

The regulatory pathway being debated is known as 505(b)(2) after the law that codifies it. A drug taking this route doesn't have to be a virtual duplicate of the branded original it's copying to be approved. Its chemistry can be slightly different, which gives the FDA a lot of flexibility in approving new drugs. The route doesn't required the original proof of safety and effectiveness mandatory for approving new brand-name drugs, nor does it demand the kinds of data necessary for the approval of regular generics. The good news is, through 505(b)(2), the FDA has approved more than 100 applications for different dosage forms such as patches, different strengths of existing medicines, and even over-the-counter switches of prescriptions drugs.

Branded generics are a hybrid. Unlike regular generics, which are biologically equivalent to a brand-name drug, they have a slightly different formulation, while intended to act in the same way as the brand-name drug. The FDA's decision allows generic-drug companies to sell some products that would compete with branded drugs before those branded drugs go off-patent (where the patent expires).

However, it isn't clear how much consumers will benefit from earlier access to these branded generics. Because they vary slightly from the original drug molecule, they can't be directly substituted at the pharmacy for the original the way true generics can be. Nonetheless, in many cases they can provide a cost-effective alternative to more expensive medicines, if properly managed under the careful management and supervision of qualified medial personnel. The present invention works in harmony with and seeks to take further advantage of such initiatives.

Medicare Asking More of Patients and Participants

Along these lines, Medicare is attaching a new requirement tied to payments. Medicare intends to use its 41 million beneficiaries to get some answers to complex medical questions. Medicare is threatening to refuse to pay unless patients are in some type of organized study. Medicare beneficiaries are the highest-volume users of the new medicines and medical devices, yet pharmaceutical companies are not getting the practical information and data that patients and doctors need to decide on effective treatments. Medicare itself has no research budget, and private companies often have a narrow commercial focus in studies they fund. With medical costs soaring, and a desire to avoid medical expenditures for unnecessary or ill-advised treatments, there exists a strong incentive for Medicare to use their marketplace leverage to force drive medical research into areas that normally would not have been high-focus.

For example, Medicare is the most commonly used payer for elderly Americans, who are also most likely to need the treatments. Thus, if Medicare insists on participation in studies, patients and drug companies will have no choice but to listen. The best way to learn about practical problems and practical benefits is to evaluate how treatments do in real world settings.

There exists an increasingly powerful array of drugs and devices, but is also broad agreement among people who make these choices that Medicare does not have all the information it needs to choose wisely. One example of this dearth of information is with cancer drugs such as biologics.

The traditional approach has been to test new cancer medicines in situations that their manufacturers think are most likely to show benefit. That leads to approval by the F.D.A. Then the drugs often come into widespread use “off-label”, where doctors give them to patients with different cancers or in combination with other drugs, thereby trying them out in new contexts. Medicare, however, is only required to pay for the original approved use and for uses listed in known formulary contexts. Outside of known formularies, payments for off-label uses are up to the discretion of local contractors such as HMOs. Some pay, while others do not.

To address this, Medicare intends to require national contractors to pay for off-label uses of the drugs for patients, in any of nine clinical trials being started by the National Cancer Institute. By doing so, Medicare hopes to encourage patients to enter the studies, which will determine whether the drugs are effective in the new contexts.

The present invention achieves additional efficiencies by apprising cardholders of this opportunity to participate in a study, and demonstrating the cost savings and benefit to themselves by doing so. Without the present invention, many uninsured and underinsured could miss this opportunity simply because they are unaware of the requirement, and are also unaware of any study presently occurring. The present invention, through its extensive computer network relationship with Medicare, local health departments, and large pharmaceutical companies, is ideally placed to facilitate such a relationship.

It is also possible to combine initiatives such as the 505(B)(2) described above, along with pediatric trials of adult medicines. As shown, Medicare is being framed around financial incentives based on human trials. Thus, Medicare relies on private sector entities to deliver drug benefits. Medicare hopes to encourage patients to enter into trials, which will determine whether the drugs are effective in the new contexts. Cardholders of the present invention could benefit by participating in such trials.

Each year, more then 65 million people go without benefits on basic prescription medication and quality health care each year in the United States. To address this, Meds Affordable Prescriptions Cards (MAPC) and Affordable Out-of-Pocket Services (AOOPS) are entities which are designed to make prescription medications more affordable, along with options to Quality Assurance Health Assistance Care Services (QAHACS). The MAPCs & QAHACS entities do not directly provide prescriptions medicines, health care services, or practice medicine. Rather, these entities operate to enable a consumer to purchase a medical card which can be used to generate considerable cost reductions in the purchase of prescription medicines and medical services. The savings advantages occur through mutually-beneficial arrangements with pharmaceutical companies, and other sponsored promotions. MAPCs and QAHACS will work with, among others, physicians, health care services providers, pharmaceutical companies, Medicare, Medicaid, and potentially other sponsors and participants.

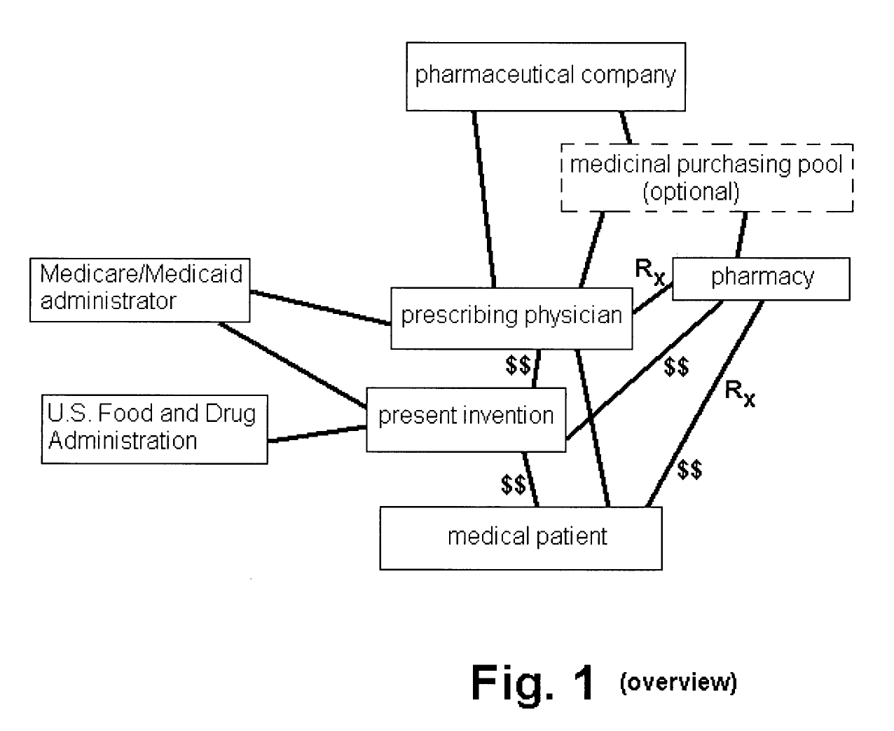

An exemplary arrangement of these entities, and their various relationships, is shown in FIG. 1. It should be noted that FIG. 1 is for exemplary purposes only, and the present invention should not be considered as being limited exclusively thereto. In FIG. 1, the present invention is shown as being positioned between a medical patient and a variety of other entities including a FDA, Medicare/Medicaid, and pharmaceutical companies, among others. Notice however that the present invention does not come between the medical patient and her physician, nor does it come between the patient and her pharmacy. If implemented properly, and the patient has inputted sufficient funds into her card account, she should be able to purchase medical services and also prescription medicines without even knowing or caring much about the present invention. In other words, her purchase of a medical card and successful maintenance thereof should shield her from having to know about the rest of the complex enterprise of the present invention.

The medical benefits cards are designed to offer prescriptions at discounted rates and access to health assistance care through a national network of participants. Under certain circumstances, cardholders can receive immediate discounts from 30% up to 60% off transactions while at the doctor's office, pharmacy counter or other point of sale (POS).

The cards of the present invention will be promoted as offering discounts from 30% up to 60% on many services. These cards can be developed into a significant growth potential for participants. According to published reports, a mere one percent increase in the use of generic drugs would equate to a more than $200 million dollars in overall sales.

Why Pharmaceutical Companies want to Participate in the Present Invention? What's in it for them?

Participating in the present invention is important to pharmaceutical companies because there's a precedent-setting element in doing so. In return for their participation, administrators of the present invention will appoint an advisory committee for formulary approval. This could result in favorable consideration to medications manufactured by a specific pharmaceutical company, if merited. Also, doctors could select preferred formulary drugs for cardholders from this formulary, as will be discussed in more detail below in the COCC/Face Value Determination section.

Once a list of participating pharmaceutical companies is compiled, a preliminary list of prescription drugs medicines can be made available. These medicines will then received preferential status within the present invention, where possible. This program offers 30% to 60% off retail prices to cardholders, partially using rebates. Pharmaceutical companies will pay substantial but undisclosed discounts in the form of rebates to participate in this selection process.

The present invention customizes different dispensing allowances based on any of a one-day supply; an individual daily dose; and/or a preferred face value drug class and quantity. From all this, a prescription drug face value amount is determined. A customer services team works with cardholders to provide key information that explains the plan rules. This information is intended to provide cardholders with accurate and detailed information about these rules.

The core purpose of the entities within the present invention is to develop and promote Network (1), (2), and (3) cards as Paid N Advance (PNA) cost effective savings cards. PNA services act as a clearing house-processor-linked with a centralized, customer assistance support mechanism which operates 24 hours/day. This mechanism is referred to as a Central Operation Command Center (COCC), which works as follows.

With COCC, the data files and databases required to adjudicate medical claims can either be stored within COCC hardware, or can be kept at each of the respective insurance companies. When using the latter, distributed approach there is no need for a centralized database having specific insurance carrier information at the medical transaction system for processing a medical claim. One advantage to this is that information to maintain a centralized database for validating claims is not required from the participating medical providers, thereby relieving them of a significant burden and thus making the present invention more attractive to participate with. However, along with this relief of burden goes a responsibility on the participants to communicate promptly and responsively with the COCC, and to have reliable computer and IT resources that are accessible at all times.

The present invention also includes the capability of receiving data messages which include adjudicated claim and remittance information from a participant's computer systems. The COCC also includes the capability to compile information from the remittance and electronic funds transfer messages, and then associates the compiled information with a physician's medical database.

For example, a healthcare provider may request medical data records of a patient in order to properly diagnose or prescribe a treatment for a patient's condition. In the case where a patient is new to a specific provider, such a transaction request for medical data records is then routed through COCC to the appropriate medical data record source, such as another healthcare provider or a centralized medical database such as that used by Medicare or Medicaid. The medical data record source, in response, provides medical data records to the requesting healthcare provider station through COCC.

The doctor may also use electronic data communications to send a formulary for prescription medications to the patient's pharmacy. The types of allowable medicines within the formulary will be described in more detail below, with particular emphasis on a Dispense as Written (DAW) designation.

The cards of the present invention are designed to keep costs down yet also provide a innovative special services featuring outside vendors companies which sponsor a wide range of human health products and quality health care services.

The success of the business entities within the present invention will center around creating & developing advantageous contractual arrangements with various participants such as medical providers, HMOs, pharmaceutical companies, and local governments and local health departments. Payment to the service networks of the present invention can occur through various types of contractual assistance services which may include various financial incentives, bonuses, and awards.

The business entities within the present invention operate as an assistance services based participate in a network of preferred physicians, health care services and qualify professional services. These groups are not employees or a part of Networks (1), (2), or (3). They are instead considered independent preferred-vendor contract providers, and are tracked within COCC using a unique identification number.

Once a participating vendor decides on a service plan design, the present invention seeks to put together a comprehensive package that suit that client's needs, wants and tastes by coordinating and selecting from many customization choices within its services network. The present invention offers special incentives and complete customize plan packages.

The present invention offers and promote an array of customize option for its affiliates. One style of cards are made as over the counter low affordable face value card ranging from five to twenty dollars. The business entities of the present invention accept most methods of payment including cash and credit cards, but will not accept or process personal checks.

To achieve the above purposes, these business entities will need to provide comprehensive packages, registrations, filing a written response to contracts, responding to legal notices, and arrange to guarantee payments to its various network providers.

The present invention will have at least the following types of employees, among others.

Customize Card Assistance Administrator/Management Team
Customize Assistance Care Coordinator/Management Team
Operation Contract Coordinator Administrators - plan design
Customize Coordination specialist
Customize Service Plan design Quality and Training Coordinator
Financial Services/Team
Customize assistance service plan designs representatives

The present invention will offer a generic first drugs formulary program which will promote sales of selected medicines. The present invention offers preferred lists of medicines and manages health assistance support through superior quality customer services. It is desired that people without benefits can be steered to formulary pre-paid cards. As a card holder, simply walk in a retail outlet, select an over the counter card display stand, or have a local registered pharmacist activate the card. A network processor within COCC will then determine all calculations, savings at the point of sale, and record all dates of services.

The cards and database of the present invention use Universal Product Code (UPC) scanner features, including but not limited to the following data fields:

Store Number
Operation Number
Transaction Employee Number
Transaction Number
Shop Card UPC Number
Shop Card Activation Account Number
Approval Code
Reference Number
Beginning Balance
Transaction Amount
Ending Balance
Date of Service
Date of Purchase
Point of Sales
Shop Card Activation Date
Shop Card Activation Time
Shop Card Activation Amount
Final Transaction Code Number

The customized plan design of the present invention applies a pre-negotiated discounts to produce savings on all card sales. Using these savings, the present invention can offer prescriptions at discounted rates and access to health assistance care through a network of health care services and medical providers.

For example, cardholders can get the following services:

Health Assistance Care Services Inquiries
Dental, Medical and Vision assistance account services
Family Assistance Account Services Inquiries
Long term maintenance assistance account services
Long term disability assistance account services
Seeking assistance care from a specialist
Accessing emergency assistance care
Accessing urgent assistance care
Accessing maps to participate locations
Community services clients
Lab, X-rays and MRI assistance services
Family practice, Internal medical, pediatrics assistance care service.
All participants can use website online services
Ability to request home delivery service envelopes
e-mail notifications about prescription and status service orders
Personalized health topics based on expressed interests

The present invention achieves cost efficiencies by working with pharmaceutical companies, health care services qualified patient professionals, community enhancement programs such as that proposed by the State of Florida as described earlier, community development partnership, public & private health department services, and neighborhood health outreach programs. The present invention has several embodiments.

Network (1)

The first embodiment of the present invention will be referred to as Network (1). The Network (1) business plan has negotiated lower fees for services, based on incentive packages and promotions which reward various providers for participating. Within the present invention, participating companies promote customized prescription assistance savings cards and customize quality assurance assistance saving advantage cards made affordable to people without benefits.

Network (2)

The second embodiment of the present invention is referred to as Network (2). What follows is a Network (2) providers listing:

Physical Therapists; Physician Assistants; Physicians Allergy; Physicians
Bariatrics (Weight Control & Weight Loss); Physicians Cardiology (heart);
Physicians Dermatology (Skin); Physicians Ear, Nose & Throat);
Physicians Endocrinology (Internal Secretion Glands); Physicians Family
Practice; Physicians Gestroenterology (Stomach & Intestines); Physicians
General Practice; Physicians Internal Medicine; Physicians Nephrology
(Kidneys); Physicians Neurology (Nervous System); Physicians
Obstetrics & Gynecology; Physicians Ophthalmology; Physicians Podiatric
(Foot & Ankle, Diabetic Foot Care, Calluses, Corns, Ingrown Toenail &
Heel Pain Specialist); Physicians Psychiatry-Child Adolescent; Physicians
Pulmonary & Respiratory Diseases; Physicians & Sports Medicine.
Pain Management: Back & Neck Pain, Personal Injury, Work and School
Physicals, Knee Problems, Bone Fractures, Dislocations, Joint Injuries and
Carpal Tunnel Syndrome; Urgent Care Facility. Arthroscopic Knee Care;
Leg Pain, Arm Pain, Tingling, and Numbness.
Dentistry: Initial Exam; Cleaning; Nitrous Oxide; Extractions; Root
Canals, & Fillings; Same day or up to 48 Hour relief of dental
emergencies.

Within Network (2), Special Assistance Options are Available on:

Crowns, Bridges, Veneers, Dentures, & Partials
Qualified Diabetic Educators' Professional Counseling
Stress Testing; Cholesterol Screening; Hypertension Management
Echocardiogram; Laser Teeth Whitening/Bleaching

To keep operation costs down and pass on cost savings, anything not listed above is deemed non-assistanced or a non-covered assistance service.

The present invention offers to people without benefits easier access to prescription medications, where Formulary Dispensing Calculations (FDC) conform to industry standard. The Network (2) will serve a conciliation service through various contractual arrangements & agreements, thereby achieving savings using pre-negotiated discounts.

Network (3)

Any non-covered items listed within Network (1) or (2) may fall within under Network (3). Network (3) achieves additionally efficiencies through predictive trials of adult medicines, pediatric trials, extended marketing exclusivity incentives, and links with Medicare patients are encouraged to enter trial studies.

To administer all the above Networks, the COCC is responsible for all client retention and contractual arrangements and agreements.

An additional part of the present invention is a plasticard manufacturing entity, which specializes in customized cards with pictures, advertisements, or other commercial messages. Along with these pictures, advertisements, or other visual placements, the following messages will also be included on the card, in various forms and sequences of which the following is but one exemplary suggestion, so that the present invention should not be considered as limited exclusively thereto. “Your use of this card constitutes acceptance of the following terms and conditions. You can add value to your card at any time. The card may not be redeemed for cash and no change will be given. Purchases will be deducted from your card until the value reaches zero. This card represents a prepayment for goods and services only, and can be redeemed only at Network (1), (2), and (3) participants. This card can not be redeemed for cash. This card cannot be replaced if lost or stolen. Please take every precaution to protect this card. Any remaining balance may be then transferred to a new card within 12 months from proof of purchase and a card number is provided and validated.”

The present invention achieves efficiencies partly through various contractual arrangements and its access to pharmaceutical companies' enormous functional infrastructure that are required to dispense drugs at the level of sophistication needed to run a program of this magnitude. To better illustrate these efficiencies, what follows is a description of preferred formulary incentives, and also closed formularies:

Explanation of Tiered Formulary System

Tier (1):
all generic drugs
insulin and disposable diabetic supplies
the retail cost-share limit is as follows: For up to a 21 day supply, the
maximum is $50. A 30-60 day supply maximum is $100. These limits do
not apply to Tier 3 drugs or prescriptions.
Tier (2):
All formulary single-source brand drugs
The retail cost-share limit is as follows: For up to a 21 day supply the
maximum is $100. Up to a 30-60 days supply the maximum is $150.
These limits do not apply to Tier 3 drugs.
Tier (3):
All non-formulary single-source drugs
All multi-source drugs

Networks (1), (2), and (3) have a limit on the quantity of medication that can be dispensed at one time per transaction. Refill dates will be calculated using actuarial timeframes and procedures. At the retail pharmacy, the minimum fill/refills dispensed under the services are one to three days supply. A customer can receive up to a 14 day supply on a short term basis.

The COCC system will have at least the following capabilities accessible by internal employees:

Participating Pharmacy Look Up
Search by PrePaid Number
Search By Client Specific Plan Accounts
Search By Names/Address/Zip code/Prescription Number
Process A Refill
Quality Check-Refills
Process A Renewal
Address Change Rules
Send Supplies
Reimbursement Process
Verify A Faxed In Prescription
Locate A Prescription On File
Authorize A Short Term Supply
PrePaid Procedure For Short Term Supply
PrePaid Manual Process for Short Term Supply
To Search For an Order In the Pharmacy

Moving Away from Home Delivery to Delivery at Home (D@H).

The reasons for this move are simple. If a company ship orders directly to a customer, that's all it is, just a shipment. The present invention seeks to improve this relationship. Because medicines are such an important part of a patient's life, shipping medicines is not like shipping books from Amazon.com. With medicines, unlike books, critical incidents will arise that will mandate interaction with a live customer service agent. Funneling to one service center can result in loss of volume and insight. Live people still need help, and not just through computers but through something with natural language capability.

The present invention resolves this by connecting all communication channels through a network of web self-service application providers, e-mail, e-channels, e-commerce vendors that provide services, voice, and linking catalogues with pricing dialogues. Predefined answers, as well as a human being if necessary, are available across all support channels. By grouping potential customers into portfolios and setting up measured channels, a single individual organization could be held accountable for managing the total stream of communication, dialogue and transactions. This concept sets the stage for a more active and rigorous management of a new class of asset, the customer relationship. The essence of this concept is treating different customers differently.

The Delivery at Home (D@H) portion of the present invention transitions independent customer on-line self-service allows customer service agents to perform routine tasks, response, conduct surveys, and discover participant savings. Such a practice increases an agent's potential, improves an organization productivity, and focus on valuable customer insight, not just on mere customer shipments.

How Agents will Effectuate Fax-In Electronic Prescriptions

To verify a faxed in prescription (for Delivery at Home option only), do the following. Check the Fax status order information selection. If no fax status information is found, check on fax status case history. If no case history is found, check “Doctor office inbound contact details”. Look for any type reason codes or entry. Check the fax in details to determine if a fax has been routed to the pharmacy. COCC's “Prescriber Fax In” status details allow users to verify or search by name of a doctor office to see any records exists for the selected search.

Fax-In & Electronic Case Management Instructions for Agents

The main objective is to answer inbound calls from physician's offices. These physicians are calling in new prescription orders. A non-pharmacist Agent will determine whom the office is calling about, where to ship the order, verify the physician's practice location, contact name and office title. This Agent will also inquire as to whether the office is calling in regard to renewing an existing prescription on file for a specific customer.

The information collected will be entered into the MAPQ's application configured for non-pharmacist use. The team application will not allow the non-pharmacist to enter any new prescription information (drug/strength/DAW/directions/refills), but will allow the selection of information already on file for a particular card holder or client patient.

Once the above information is entered into the application, the non-pharmacist will send the order to a “Fax-In Electronic Prescription Case Management” portion of the COCC, receive a case number, and then transfer the call and case number to the pharmacist.

The case will automatically display on the pharmacist's workstation. Pharmacists will take all new prescription information by telephone, electronic prescriptions devices, prescription pad renewals, verify the accuracy of any renewal information and be involved in all professional communications.

Agent scripting can include the following: “Thank you for calling fax in electronic prescriptions services, my name is ______. I am a Pharmacy Customer Service Agent. Are you calling from a doctor's office?” Similarly, the following Fax-In scripts may be presented after the disclosure salutation: “Would you like to be provided with a fax form to fax your order to us?” If the office prefers to call in the order, then the following lead in script will be used. “That will be fine. Let me go ahead and take some information about the order before I transfer you to a pharmacist”.

One of the primary expectations of an Agent's assignments is to verify the correct person, has been chosen and the correct shipping address is on file. The cardholder or patient's shipping address may not necessarily be the same as the patient name verification. Occasionally a family member will have a last name that is different than the card holder or client patients. It is also necessary to verify patient's date of birth.

The Agent should continue the case building process and close the call with the following call transfer script: “Thank you for the information. I will transfer you to the next available pharmacist who will take the prescriptions”.

The COCC system allows an employee internal to the present invention to make address changes as follows:

Establish or select a previous shipping address.
Highlight the previous address.
Move the cursor to “shipping address” section. Click “Clear” button to
type new address.
Change part or all of a previous address. Click or type in changes in
fields to change.
Process the new address. Click on the “Select” button.
TO SEND MEDICINES
1. Highlight the line of information next to the items requested
2. Enter the number of items requested by the customer in the
“Qty” column only if it is greater than the standard request amount.
3. Click on “Select” to process the order
TO VERIFY A FAXED-IN PRESCRIPTION (Home Delivery Options
Only)
1. Check the “Fax Status Order Information” selection
2. If no fax status info is found, click on “Fax Status Case History”.
3. If no case history if found, check “Dr's Office Inbound Contact
Summary” field. Look for any type reason codes or entry. Check the
“Faxed Drug Rx's” to determine if a fax has been routed to the pharmacy.
NOTE:
The “Prescriber Fax Status” fields allow users to verify or search by name of a Dr's office to see any records exist for the search you selected.

Quantity Prepaid Dispensing Program (QPDP), a Cost Control Mechanism

For certain high ends or multi-source drugs dispensed both via mail and retail (pharmacy), cardholders may have limitations on medication amounts. These limitations and the logic behind them are part of the cost control mechanism of the present invention, known as the Quantity Prepaid Dispensing Program (QPDP). These limitation amounts are necessary in order to make prescription drugs more affordable at the counter. Customer service teams and also cardholders will need to understand that there is a limit on the quantity of medication that can be dispensed at one time.

Within the COCC operator interface, where the account of a specific cardholder is being queried, a QPDP message pop-ups will show two pieces of very important information: 1) a maximum quantity of medication dispensable; and 2) whether the client or participant has agreed to sponsor a coverage review process. If 2) is negative, then “no more” medicine truly means “no more”, and that the decision is final. The decision of the specific participant is unappealable and the cardholder receives no additional medicines or services. However, if 2) is affirmative, a 1-800 COVERAGE APPEAL number is offered which cardholders may refer to if they are interested in requesting a coverage review for a QPDP limitation.

To achieve cost efficiency, a core feature of the present invention is that not all Network (1) (2) or (3) designs will have a coverage review process. In some cases, only the doctor's office can then request a coverage review on behalf of the patient cardholder. When additional quantities are approved (either through prior authorization or QPDP coverage review process), the approval will be reflected within the COCC as Prior Authorization Approved (PAA), or QPDP APPROVED (QPDP-A).

If the coverage review is denied, the patient may continue to get the medication, but only in the quantity permitted under the QPDP limitation per PrePaid face value. There is no limitation on the number of times a patient cardholder may request a coverage review on a specific medication. However, QPDP coverage review can only be performed by either an internal employee or a participant, and not by a cardholder.

If the coverage review is denied, a pharmacist or other participating provider will get one of two point-sale (POS) messages. Both messages will show the QPDP quantity limitation: One of the messages will also have the 800 coverage review number and the other will not. The options for the retail pharmacist are to dispense the Rx using the QPDP limitations, or return the un-dispensed Rx to the cardholder. If there is a coverage review 800 number and the cardholder requests it, the pharmacist can offer to contact the doctor or provide the 800 number to the cardholder to give to their doctor, who can then request a coverage review. If the coverage review is denied in situations involving medicines by mail, similar messaging will appear, and the RX will be dispensed at the lesser QPDP-approved quantity.

In some cases, this may be the first time a cardholder is informed about the QPDP quantity limitation on the medication. They will be expecting a specific quantity and will receive less than they anticipated. The patient will probably be confused, frustrated and possibly angry. Skilled customer service team members with access to COCC information must always be prepared to mollify disappointed cardholders.

Some medications with quantity limitations under QPDP will not have a coverage review 800 number. In this case the caller may be so unhappy that they may press and request inappropriate things like a referral to a customer service pharmacist, or a referral to a managed care pharmacist, or a coverage review 800 number.

However, none of these steps is the best way. Customer service personnel must adhere to a standard reply of “the quantity of medication sent to you, or dispensed at the point of sale, is correct. The dispensed amount was reduced due to our plan design limitation on this medication. As you are probably aware, costs for prescription medicines are high. Through the use of this type of plan, our group is able to provide discounts and access to many costly medications. This is why you received less than you anticipated.”

The present invention can only dispense up to a one year supply of medication on rechargeable card. After one year, a new card must be purchased. Cards expire one year from the card issued activation date of service (the date the card is enabled in the present invention's tracking system). In some cases, the expiration date could be effective by the point of sales or date of purchase, but this can vary depending on the specific plan designed by a participant.

Under very extreme circumstances (not an in-house error) that warrants a senior level approval to grant an offer of limited supply at no cost, overrides can be permitted. However, these overrides are only to assist participants inconvenienced by extreme circumstances. Authority to override can only be granted for up to (5) five days and or not to exceed the dispensing amount of $100.00 worth of a medication's supply. COCC will generate an alert if such a transaction exceeds that predetermined amount.

How Cocc Determines a Face Value Amount to Assesss the Card-Holder

A key field in the computation of face value amount that a cardholder must pay is DAW (Dispense As Written). This is an indication from a prescribing physician to a pharmacist that a specific medicine is desired, and if possible to not substitute another medication. However, the DAW field can have several different values depending on how strongly it is desired to stay with a specific medicine, balanced against how strongly it is desired to achieve cost savings, as explained in the following. This concept is sometimes also referred to as brand medically necessary (BMN).

Another term popularly used in this context is “substitution indicator”. For example, a patient's plan may permit substitutions, but a doctor may be aware that the patient has a certain reaction to a specific substitute medicine. In such a case, the substitution indicator can be used to disallow substitutions of certain medicines, while allowing others.

The following DAW codes are considered acceptable by the National Council for Prescription Drug Programs (NCPDP).

| | |
|---|---|
| 0 | No DAW |
| 1 | Physician DAW |
| 2 | Patient DAW |
| 3 | Pharmacy DAW |
| 4 | No Generic Available |
| 5 | Brand Dispensed as Generic |
| 6 | Override |
| 7 | Brand Drug Mandated by Law |
| 8 | Generic Drug Not Available in Marketplace |
| 9 | Other |

Face Value Category 1: Flat Dollar % PrePaid Amount

Within this category, the cardholder pays a flat dollar amount as indicated in the Amount 1 field on the preferred drug list of the client profile. When this face value category is used, the card holder pays a flat dollar amount as indicated in the Amount 1 or Amount 3 fields on the face value screen of the client profile. When the MED B COB (Medicare ‘B’ Cost of Benefits) Participation Indicator equals 1 (Yes), the Amount 3 field is allowed to be populated and the face value for MED B drugs will be taken from the Amount 3 field.

Face Value Category 2: Prepaid % Amount

When this category is used, the card holder pays a face value equal to a percentage of the approved amount based on ingredient cost, plus tax, plus professional fees. The percentage is indicated in the Percent 1 Preferred list (screen) of the client profile.

Face Value Category 3: Full Difference/Dollar Amount, Not DAW (Dispense as Written) Sensitive.

Within this category, the cardholders are responsible for a flat dollar amount, plus the difference between the multi-source brand price and the full Health Care Financing Administration Maximum Allowable Cost (HCFA-MAC) price of the drug. The flat dollar amount is indicated in the Amount 1 field on the Preferred List (screen) of the Client Profile. When a Multi-Source drug is processed and the Federal Upper Limit (FUL) indicator is equal to zero, then the Single source Face value Amount will be taken. When the DAW indicator is equal to 3 or 5, then the generic face value category will be used. When the DAW indicator is equal to 7, the single source face value category will be used.

If the DAW indicator is equal to zero, and the HCFA price is available, then the generic face value will be used. If the DAW indicator is equal to zero, and the HCFA price is not available, then the Single source Face value category will be used. When the DAW indicator is equal to 1, 2, 4, 6, 8, or 9 and the FULL price is available, the Face value will be the Multi-source Face value plus the difference between the brand and FUL price. If the FUL price is equal to zero then the Single source Face value category will be used.

This category may only be used with multi-source drugs. Note: If the DAW indicator is equal to zero, then the generic face value amount will be used.

Face Value Category 4: Full Difference % (Not DAW Sensitive)

In this instance, the card holder face value amount is equal to a percentage of the approved amount (ingredient cost, plus tax, plus professional fees) and the difference between the multi-source brand drug and the full price. The percentage is indicated in the Percent 1 field on the preferred list (screen) of the Client Profile.

When the DAW indicator is equal to:

| | |
|---|---|
| 3 and 5 | Generic Face value category is used |
| 7 | single source Face value category |
| 0, 1, 2, 4, 6, 8, or 9 | If the FUL price is greater, then the |
| | Multi-source Face value is taken plus |
| | the difference between the brand and |
| | FUL price |
| 0, 1, 2, 4, 6, 8, or 9 | If the FUL is equal to zero, Single source |
| | Face value is used |

Face Value Category 5: Full Difference % DAW

When this Face value Category is used, when a card holder pays the greater of a percentage (Percent 1 Field) of the approved amount (generic ingredient cost plus tax plus professional fees). In addition, if the DAW indicator is not equal to 1 (Physician DAW), 3 (Pharmacy DAW), or 5 (brand dispensed as a generic), the card holder must pay the difference between the cost of the multi-source brand drug and the FUL price. This Face value Category may only be used with Multi-source type of medicines.

Face Value Category 6: % Plus Amount

With this Face value Category, the Face value is a percentage (Percent 1 field) of the approved amount (ingredient cost, plus tax, plus professional fees) plus a flat dollar amount.

Face Value Category 7: Amount with Multi-Source %

When this Face value Category is used, if the DAW indicator equals 1 (Physician DAW), the card holder pays a flat dollar amount (Amount 1 field) based on days supply dispensed (“days” field) up to 3 times the amount in the amount 1 field.

For example, if the face value preferred list indicates 020 in the “Days” field and $5.00 in the “Amount 1” field, the card holder pays $5.00 for each 20 day supply dispensed up to 3×$5.00 (where the 3× is hardcoded). If the DAW indicator is not equal to 1, the face value is equal to a percentage (“Percent 1” field) of the approved amount (ingredient cost, plus tax, plus professional fees). When the “Percent 1” field is 100, the claim is rejected. This face value category may only be used with multi-source medicines.

Face Value Category 8: % Ingredient Cost+Professional Fees+Full Difference

In this instance, the Face value Category would include the professional fees, plus a percentage (“Percent 1” field) of the ingredient cost, plus the different between the cost of the brand and the full price. This copay category may only be used with multi-source medicines.

Face Value Category 9: One Face Value Per Vial of Insulin

In this instance, a separate face value is taken for each vial of insulin dispensed. For all other medications, the face value is based upon the days supply of the drug which was dispensed. For insulin claims, the metric quantity dispensed is divided by 10 to determine the number of vials dispensed. The Face Value amount indicated in the Amount 1 field is then multiplied by the number of vials. For example, the Amount 1 field reflects $5.00 and the metric quantity on the claim is 30. This Face Value would be calculated as follows:
30/10=3×$5.00=$15.00 Face Value

For non-insulin claims, a separate face value is taken for each days supply as indicated in the “Days Supply” field, up to 3 times the amount 1 field. For example, The “Days Supply” field reflects 030, the “Amount 1” field reflects $5.00, while the days supply field on the claim itself is 60. The face value would be calculated as follows:
60/30=2×$5.00=$10.00 Face Value
Face Value Category 10: Split Family

Here, the cardholder will pay the face value dollar or percent in the amount 1 or percent 1 field. When the drug is a multisource National Drug Code (NDC) with the substitution indicator of X and the DAW (Dispense As Written) value is 0, 1, 2, 4, 6, 8, or 9, either the “Amount 1” or “Percent 1” field (whichever has a value greater than zero), will be used. When the both have zero, the Amount field will be used to calculate the face value amount.

When the DAW is 3 or 5, the generic face value option, either the “Amount 1” or “Percent 1” field (whichever has a value greater than zero), will be used. When both have zero, the “Amount 1” field will be used to calculate the face value amount.

Face Value Category 11: Drug Specific/Flat Dollar Amount %

With this category, the cardholder pays one face value (either a flat dollar amount or a percentage of approved amount) for specific drugs, and a different face value for all other drugs. When this category is used with MAC, multi-source claims are processed with a DAW indicator of 0, 4, 6, 8, or 9, and there is a Mac price on the drug, the claim will price generically, however the member will be charged the Brand Face Value.

The specific list of drugs appears on the face value drug list selection of the formulary file. The face value amounts and percentage do not appear on the “Client Profile Face Value” screen. They can only be viewed by accessing the “Tier Face Value” screen.

Face Value Category 12: Generic Difference Dollar/DAW Days Supply

With this face value category, the number pays a selected dollar amount every “x” number of days supply (in the Amount 1 Field) based upon the day supply of the drug dispensed. In addition, the member pays the difference between an approved ingredient cost and the average generic price when the DAW is not 1, 3, or 5. This face value category is similar to Category 5.

Face Value Category 13: Medicare/Non-Medicare/Flat Dollar Amount or %

Within Category 13, the member eligibility (cardholder) file contains a Medicare flag, and also a Medicare effective date. If this flag is equal to “YES” and the date of service on the Mail Service claim is greater than the Medicare effective date on the Member Master file, the cardholder will pay one flat dollar amount Face value (“Amount 1” field) or a percent Face value (based on “Percent 1” field). If the Medicare flag is “NO”, the member will pay a different Face value (“Amount 2” field) or a percent face value based upon the “Percent 2” field.

Face Value Category 14: Drug Specific/Paid MAC

Within this category, the cardholder pays one face value (either a flat dollar amount or a percentage of the approved amount) for a specific list of drugs based on drug list, and a different face value for all other drugs, either a flat amount or percent. The specific list of drugs are given a Formulary Type and Formulary ID. In addition this face value option can only be used for multi-source drugs, and therefore will pay the following way based on the DAW code submitted by the pharmacy.

If the DAW indicator is 0, 3, 4, 5, 6, 8, or 9, then the generic amount or percent is used. If the DAW indicator is a 1, then the multi-source face value or percent is used. If the DAW indicator is a 2, then the multi-source amount or percent is used, and the card holder is also responsible for the difference between the brand and the MAC price. If the DAW indicator is a 7, then use the single source amounts or percents.

It is anticipated that various changes may be made in the arrangement and operation of the system of the present invention without departing from the spirit and scope of the invention, as defined by the following claims.

1. A prescription benefits enterprise, comprising:
a centralized computer and operations center which simultaneously communicates with pharmacies, pharmaceutical companies, local health departments, state and local governments, Medicare and Medicaid providers, and participating doctor's offices, in order to facilitate the flow of prescription medicines and medical services to purchasers of a pre-paid medical benefits card;
wherein said card is formatted to manage and update data regarding the specific medicines and medical services that have been received by a holder of said card; and
further wherein said centralized computer and operations center debits costs for medical services from said card and credits payments made to said card.

2. The enterprise of claim 1, further comprising:
a first network of providers and services, wherein said participants provide a first level of medicines and medical services.

3. The enterprise of claim 2, further comprising:
a second network of providers and services, wherein said participants provide a second level of medicines and medical services that encompasses but also extends beyond said first level.

4. The enterprise of claim 3, further comprising:
a third network of providers and services, wherein said participants provide a third level of medicines and medical services that encompasses but also extends beyond said second level.

5. The enterprise of claim 4, further comprising:
said providers perform medical trials and studies including pediatric trials in combination with cost reductions mandated under FDA 505(B)(2).

6. The enterprise of claim 1, further comprising:
said centralized computer and operations center having a means for calculating a face value of a medicine or service to be deducted from an account of a cardholder, wherein said means for calculating includes a variety of dispense-as-written values.

7. The enterprise of claim 6, wherein said face value is calculated using a flat dollar percentage amount.

8. The enterprise of claim 6, wherein said face value is calculated using a prepaid percentage amount.

9. The enterprise of claim 6, wherein said face value is calculated using a full difference/dollar amount which disregards dispense-as-written instructions.

10. The enterprise of claim 6, wherein said face value is calculated using a full difference percentage which disregards dispense-as-written instructions.

11. The enterprise of claim 6, wherein said face value is calculated using a percentage plus amount instructions.

12. The enterprise of claim 6, wherein said face value is calculated using an amount with multi-source percentage instructions.

13. The enterprise of claim 6, wherein said face value is calculated using a percentage plus ingredient cost plus professional fees plus full difference instructions.

14. The enterprise of claim 6, wherein said face value is directed at diabetics and is calculated using a one Face Value Per Vial of Insulin

15. The enterprise of claim 6, wherein said face value is calculated using split family instructions

16. The enterprise of claim 6, wherein said face value is calculated drug specific flat dollar amount percentage instructions.

17. The enterprise of claim 6, wherein said face value shall be calculated using a generic difference dollar and dispense-as-written days supply instructions.

18. The enterprise of claim 6, wherein said face value shall be calculated using either medicare or non-medicare or flat dollar amount or percentage instructions.

19. The enterprise of claim 6, wherein said face value shall be calculated using a drug-specific paid MAC instructions.

20. The enterprise of claim 1, wherein quantities of said medications are monitored and controlled using a quantity prepaid dispensing program cost control mechanism.

21. The enterprise of claim 1, wherein said costs for medicines are affected by initiatives which are intended to increase the usage of generic formulations.

22. The enterprise of claim 1, wherein said costs for medical services are affected by exclusivities granted to pharmaceutical companies in exchange for increasing their amount of pediatric testing of medicines.

23. The enterprise of claim 1, wherein said costs for medical services are affected by a Florida Medicaid initiative.

24. The enterprise of claim 1, wherein said costs for medical services and medicines are affected by multi-state purchasing pools.

25. The enterprise of claim 1, wherein said costs for medicines are affected by the United State Food and Drug Administration's 505(b)(2) initiative.

26. The enterprise of claim 1, wherein said costs for medical services and medicines are affected by medicare forcing recipients to participate in studies as part of receiving coverage.
